(19) United States
(12) Patent Application Publication
(10) Pub. No.: US 2005/0224128 A1
(43) Pub. Date: Oct. 13, 2005

(54) Hose with high flexibility and heat resistance, and low permeability

(75) Inventors: Piero Mancinelli, Pescara (IT); Gianluca Dolente, Alba Adriatica (IT); Vincenzo Salvia, Colli Del Tronto (IT); Paolo Reali, S. Egidio Alla Vibrata (IT)

Correspondence Address: MODIANO & ASSOCIATI, Via Meravigli, 16, MILANO, 20123, IT

(73) Assignee: MANULI AUTOMOTIVE S.p.A.

(21) Appl. No.: 11/097,196

(22) Filed: Apr. 4, 2005

(30) Foreign Application Priority Data
Apr. 8, 2004 (IT) MI2004A000704

(51) Int. Cl. F16L 11/00

(52) U.S. Cl. 138/141

(57) ABSTRACT

A hose with high flexibility and heat resistance, and low permeability to greenhouse gases, particularly for climate control, conditioning and refrigeration systems, for vehicles and fixed installations, comprising at least one outer layer made of rubber, and at least one layer of flexible thermoplastic material coupled to at least one layer of impermeable thermoplastic material, the latter layers constituting an inner core of the hose.

The present invention relates to a hose with high flexibility and heat resistance, and very low permeability. More particularly, the invention relates to a hose that is adapted for climate control, conditioning and refrigeration systems for vehicles and fixed installations.

### BACKGROUND OF THE INVENTION

As is known, the environmentally-friendly orientation of current and future environmental standards entails the maximum possible reduction of the emission of greenhouse gases into the environment.

Climate control, conditioning and refrigeration systems are among the main devices responsible for these emissions. Substantially, these systems are provided with flexible hoses, whose flexibility allows to mutually connect components that vibrate with respect to each other. This flexibility is achieved by using polymeric materials, whose molecular structure is substantially amorphous.

The emission of gases into the atmosphere is caused by the permeation of the gases, which pass through flexible hoses, and is highly dependent on the nature of such flexible hoses. In particular, as the degree of crystallinity of the material of which the hose is made increases, the permeability through such hose decreases.

However, from a mechanical standpoint, as the degree of crystallinity increases, so does the brittleness of the material, and therefore its ability to deform elastically decreases and so does its fatigue strength.

However, the deformability and fatigue-strength characteristics are critical for flexible hoses adapted for conveying gases under pressure and subjected to fatigue.

Flexible hoses for conveying coolant gases are currently divided into two groups: the first group consists of hoses with a thick rubber base layer, and the second group has a single thin thermoplastic flexible layer that acts as a gas barrier.

### SUMMARY OF THE INVENTION

The aim of the present invention is to provide a hose with high flexibility and very low permeability that can be used in climate control, conditioning and refrigeration systems, ensuring extremely low emissions of gases into the atmosphere, thus helping to reduce the presence of greenhouse gases in the environment.

Within this aim, an object of the present invention is to provide a hose that combines the characteristics of extremely low permeability with high flexibility, in order to allow its use in conditioning, climate control and refrigeration systems.

Another object of the present invention is to provide a hose that also has a high heat resistance and mechanical strength.

Another object of the present invention is to provide a hose that is highly reliable, relatively simple to provide, and at competitive costs.

This aim and these and other objects that will become better apparent hereinafter are achieved by a hose with very high flexibility and very low permeability to refrigeration gases, particularly for climate control, conditioning and refrigeration systems, for vehicles and fixed installations, which comprises at least one outer layer made of rubber, characterized in that it comprises at least one layer of flexible thermoplastic material coupled to at least one layer of impermeable thermoplastic material, said at least one layer of flexible thermoplastic material and said at least one layer of impermeable thermoplastic material constituting an inner core of said hose.

### BRIEF DESCRIPTION OF THE DRAWINGS

Further characteristics and advantages of the invention will become better apparent from the description of preferred but not exclusive embodiments of the hose according to the invention, illustrated by way of non-limiting example in the accompanying drawings, wherein:

FIG. 1 is a cutout perspective view of the hose according to a first embodiment of the present invention; and

FIG. 2 is a cutout perspective view of the hose according to a second embodiment of the present invention.

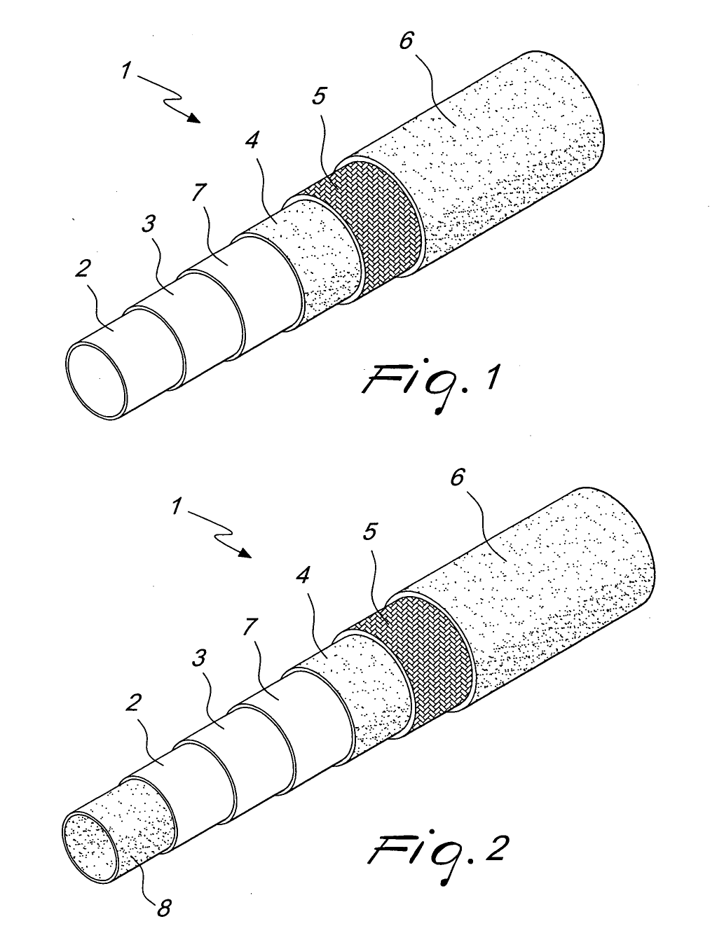

### DESCRIPTION OF THE PREFERRED EMBODIMENTS

With reference to the figures, the hose according to the present invention, generally designated by the reference numeral 1, comprises at least one layer 2 made of flexible thermoplastic material, on which there is at least one layer 3 made of impermeable thermoplastic material, on which there is further at least one layer of rubber 4, which in turn is covered by a reinforcement layer 5, and on which an additional layer of rubber 6 is finally arranged.

The layer 2 is made of polyamide 6 modified with elastomers, such as polyolefins, in order to allow the polyamide to be flexible. The layer 3 is conveniently made of EVOH.

Conveniently, the hose according to the invention can further comprise, between the layer of impermeable thermoplastic material 3 and the layer of rubber 4, a layer 7 of flexible thermoplastic material, which is similar or not to the layer of flexible thermoplastic material 2.

However, the layer 7 also is made of polyamide 6 (PA6), which is rendered flexible so that the layer 3 made of EVOH is interposed between the two flexible layers 2 and 7.

This configuration ensures an extremely high breaking elongation (approximately 180%) and a heat resistance which is higher than known hoses.

The hose according to the invention, according to a second embodiment thereof, can have, inside the first layer of flexible thermoplastic material 2, an additional layer of rubber 8, as shown in FIG. 2.

In this case, the layer of thermoplastic material 2 and the layer of impermeable thermoplastic material 3 are arranged between two layers of rubber, designated by the reference numerals 8 and 4 respectively.

Substantially, according to the invention the hose is provided by means of a coupling of a plurality of layers, in which the layer of flexible thermoplastic material 2 constitutes the inner wall of the hose, according to the first embodiment, or the first layer arranged on the inner rubber layer 8, according to the second embodiment.

Such layer or combination of flexible thermoplastic layers constitutes a gas barrier. Flexibility is achieved by then reducing the thickness of the impermeable layer 3, typically by using highly crystalline and rigid materials. Bonding of this layer with other thermoplastic or flexible layers allows deformation (as a consequence of pressure inside the hose) without damage.

Therefore, the first embodiment shows a hose with a thermoplastic base layer provided by the flexible thermoplastic layer 2, while the second embodiment illustrates the hose with a thermoplastic base layer arranged between the rubber layers 8 and 4.

In practice it has been observed that the hose according to the invention fully achieves the intended aim and objects, since it allows to provide a hose that is highly flexible, like the hoses currently used in refrigeration, conditioning, climate control systems and the like, yet allows the hose to have extremely low leakage by permeation therethrough, so as to avoid contributing to the emission of gases into the atmosphere.

Moreover, the hose thus provided is extremely resistant to internal and external deformations, thanks to the coupling of two different types of thermoplastic flexible and impermeable materials.

The hose thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. MI2004A000704 from which this application claims priority are incorporated herein by reference.

1. A hose with high flexibility and heat resistance, and very low permeability to refrigeration gases, particularly for climate control, conditioning and refrigeration systems, for vehicles and fixed installations, comprising at least one outer layer made of rubber, characterized in that it comprises at least one layer of flexible thermoplastic material coupled to at least one layer of impermeable thermoplastic material, said at least one layer of flexible thermoplastic material and said at least one layer of impermeable thermoplastic material constituting an inner core of said hose.

2. The hose according to claim 1, further comprising a layer of rubber arranged around said at least one layer of impermeable thermoplastic material.

3. The hose according to claim 1, further comprising an additional layer of rubber arranged inside said at least one layer of flexible thermoplastic material.

4. The hose according to claim 1, comprising a reinforcement layer arranged around said rubber layer arranged around said at least one layer of impermeable thermoplastic material.

5. The hose according to claim 1, comprising a second layer of flexible thermoplastic material, which is coupled to said layer of impermeable thermoplastic material.

6. The hose according to claim 1, wherein said at least one layer of flexible thermoplastic material is made of polyamide 6 modified with polyolefins.

7. The hose according to claim 5, wherein said second layer of flexible thermoplastic material is made of polyamide 6 modified with polyolefins.

8. The hose according to claim 1, wherein said layer of impermeable thermoplastic material is made of EVOH.
